(19) United States
(12) Patent Application Publication
(10) Pub. No.: US 2024/0093017 A1
(43) Pub. Date: Mar. 21, 2024

(54) RECYCLED POLYSTYRENE PLASTIC FILM, ACOUSTO-MAGNETIC ANTI-THEFT LABEL, ACOUSTO-MAGNETIC ANTI-THEFT LABEL HOUSING, AND PREPARATION METHODS THEREOF

(71) Applicant: Ningbo Signatronic Technologies, Ltd., Ningbo (CN)

(72) Inventors: Shu Zhang, Ningbo (CN); Lijing Yu, Ningbo (CN); Na Liao, Ningbo (CN); Mei Yang, Ningbo (CN)

(21) Appl. No.: 18/520,591

(22) Filed: Nov. 28, 2023

Related U.S. Application Data
(63) Continuation-in-part of application No. PCT/CN2021/117613, filed on Sep. 10, 2021.

(30) Foreign Application Priority Data
May 28, 2021 (CN) 202110592551.1
Jul. 2, 2021 (CN) 202110753099.2
Jul. 2, 2021 (CN) 202121507879.0
Jul. 26, 2021 (CN) 202110845386.6

(51) Int. Cl. C08L 25/06; B29B 9/12; B32B 1/00; B32B 27/08; B32B 27/30; B32B 27/32; C08J 5/18; C08K 9/04; G08B 13/24

(52) U.S. Cl. CPC C08L 25/06; B29B 9/12; B32B 1/00; B32B 27/08; B32B 27/302; B32B 27/32; C08J 5/18; C08K 9/04; G08B 13/2434; G08B 13/2442; B29K 2025/06; B32B 2250/02; B32B 2250/246; B32B 2272/00; B32B 2307/31; B32B 2307/7376; B32B 2519/00; C08J 2325/06; C08J 2409/06; C08J 2453/02; C08L 2203/16; C08L 2207/20

(57) ABSTRACT

Disclosed is a recycled polystyrene (PS) plastic film prepared from 100% of a waste PS plastic or prepared from a waste PS plastic and a modification material, where a content of the waste PS plastic is greater than or equal to 1% and less than 100% and a content of the modification material is greater than 0% and less than or equal to 99%. The preparation of the recycled PS plastic film with the waste PS plastic can save resources. In addition, the waste PS plastic is modified by the modification material to improve the performance of the plastic, which is conducive to preparation of an acousto-magnetic (AM) anti-theft label housing with excellent performance. Also disclosed are a preparation method of the recycled PS plastic film, an AM anti-theft label housing made of the recycled PS plastic film and a preparation method thereof, and a corresponding AM anti-theft label.

### CROSS-REFERENCE TO RELATED APPLICATIONS

The present application is a continuation-in-part application of PCT application No. PCT/CN2021/117613 filed on Sep. 10, 2021, which claims the benefit of Chinese Patent Application No. 202110592551.1 filed on May 28, 2021, Chinese Patent Application No. 202110753099.2 filed on Jul. 2, 2021, Chinese Patent Application No. 202121507879.0 filed on Jul. 2, 2021 and Chinese Patent Application No. 202110845386.6 filed on Jul. 26, 2021. The contents of all of the aforementioned applications are incorporated by reference herein in their entirety.

### TECHNICAL FIELD

The present disclosure relates to the technical field of materials, and in particular to a recycled polystyrene (PS) plastic film, an acousto-magnetic (AM) anti-theft label, and a label housing, and preparation methods thereof.

### BACKGROUND

The current AM anti-theft labels generally have a multi-layer structure composed of a plastic housing (which is mainly formed by a PS film/polyethylene (PE), amorphous resonators, a semi-hard magnetic bias, a PE/polyethylene terephthalate (PET) sealing cover material, a self-adhesive sticker paper, and the like. The AM anti-theft labels are highly-demanded disposable consumables. The AM anti-theft labels are mainly used for anti-theft in places such as global retail supermarkets, and chain stores, with an annual consumption of tens of billions. The AM anti-theft labels are mainly attached to commodity packagings, and can be demagnetized after corresponding commodities are selected and paid by a customer at a cash register. If a thief tries to take a commodity out of a store without paying for the commodity, a label on the commodity will trigger an alarm when passing through an AM alarm antenna at a door, thus achieving an anti-theft effect. After a customer pays for a commodity, a label on the commodity is demagnetized and decoded by a cashier, and thus the commodity will no longer trigger an alarm when taken out of a store. The AM anti-theft labels are currently an important anti-theft measure for self-service of the retail industry. PS in used and discarded labels cannot be recycled and is easy to pollute the environment. As the “Plastics Reduction Orders” were launched in various countries, businesses require an AM label that uses a recycled plastic to some degree to complete the increasingly-enhanced environmental protection task.

Those skilled in the art generally believe that there are specified requirements on the mechanical properties such as fluidity, bending strength, impact strength, and elongation at break and stability of a housing PS plastic of an AM anti-theft label. Generally recycled PS resins on the market, are mostly recovered from rigid thick plate products which is originally made of virgin high-impact polystyrene (HIPS), such as waste television (TV) housings. Because thick plates made with recycled PS will be easy to break, the person skilled in the art does not think of using such recycled PS resin to prepare flexible and ductile PS film of a 0.20 mm-0.45 mm thickness qualified to make AM labels housing. Gel chromatography analysis results show that such waste PS materials on the market have a reduced molecular weight, a widened molecular weight distribution, and an increased particle dispersion (PD) value. For example, waste PS plastics are degraded into small molecules to some degree after long-term use. Although it is calculated according to a definition of a number-average molecular weight of a polymer that 84% or more of macromolecules in a waste PS plastic do not undergo chain breakage and degradation. Mechanical property test results of waste HIPS plastics show that, compared with a virgin HIPS plastic, the impact strength decreases significantly, and the notched izod impact strength decreases to 5.7 kJ/m². These waste HIPS plastics no longer have high impact resistance, and have changed to general PS. According to the above data, those of ordinary skill in the art believe that the recycled PS materials on the market have relatively poor performance, are prone to brittle fracture, and can hardly meet the requirements of manufacturing AM anti-theft soft label housings. Therefore, at present, there are only a few brands of virgin HIPS materials on the market are qualified to make AM anti-theft label housings. But no any AM anti-theft labels housings are made by recycled PS materials currently.

### SUMMARY

An objective of the embodiments of the present disclosure is to overcome the aforementioned technical pain points and provide a recycled PS plastic film, an AM anti-theft label, and a label housing, and preparation methods thereof. In the present disclosure, a waste PS plastic can be used to prepare a recycled PS plastic film to save resources and meet the urgent needs of customers for eco-friendly AM anti-theft labels.

In order to solve the above technical problems, an embodiment of the present disclosure provides a recycled PS plastic film, including a waste PS plastic and a modification material, where based on a total weight of the recycled PS plastic film, a content of the waste PS plastic is greater than or equal to 1% and less than or equal to 100% and a content of the modification material is greater than or equal to 0% and less than or equal to 99%.

In some embodiments, a thickness of the recycled PS plastic film is 0.20 mm to 0.45 mm.

In some embodiments, based on the total weight of the recycled PS plastic film, the content of the waste PS plastic is 100% and the content of the modification material is 0%.

In some embodiments, the recycled PS plastic film includes the waste PS plastic and the modification material, where based on the total weight of the recycled PS plastic film, the content of the waste PS plastic is greater than or equal to 1% and less than 100% and the content of the modification material is greater than 0% and less than or equal to 99%.

In some embodiments, based on the total weight of the recycled PS plastic film, the content of the waste PS plastic is 10% to 76% and the content of the modification material is 24% to 90%.

In some embodiments, the modification material includes at least one selected from the group consisting of a virgin PS material and an additive.

In some embodiments, the additive includes a toughening agent.

In some embodiments, the toughening agent includes at least one selected from the group consisting of a styrene-butadiene-styrene block copolymer (SBS) and a styrene-butadiene rubber (SBR).

In some embodiments, the additive further includes organic montmorillonite (OMMT), and the toughening agent is SBS; and based on the total weight of the recycled PS plastic film, a content of the SBS is greater than 0% and less than or equal to 25% and a content of the OMMT is greater than 0% and less than or equal to 6%.

In some embodiments, based on the total weight of the recycled PS plastic film, a content of the SBS is 20% and a content of the OMMT is 4%.

In some embodiments, the additive further includes OMMT, and the toughening agent is SBR; and based on the total weight of the recycled PS plastic film, the content of the SBR is greater than 0% and less than or equal to 35% and the content of the OMMT is greater than 0% and less than or equal to 6%.

In some embodiments, based on the total weight of the recycled PS plastic film, the content of the SBR is 30% and the content of the OMMT is 4%.

In some embodiments, the additive further includes OMMT, and the toughening agent includes SBS and SBR; and based on the total weight of the recycled PS plastic film, the content of the SBS is greater than 0% and less than or equal to 25%, the content of the SBR is greater than 0% and less than or equal to 35%, the content of the OMMT is greater than 0% and less than or equal to 6%, and a total content of the SBS, the SBR, and the OMMT is less than or equal to 60%.

In some embodiments, the waste PS plastic is a waste HIPS plastic; the recycled PS plastic is a recycled HIPS plastic. In some embodiments, the recycled PS plastic prepared from the waste PS plastic is a recycled HIPS plastic. In some embodiments, the recycled PS plastic prepared from the waste PS plastic and the modification material is a recycled HIPS plastic.

In order to solve the same technical problems, an embodiment of the present disclosure also provides a method for preparing the recycled PS plastic film, including:
S1: mixing the waste PS plastic and the modification material to obtain a mixture;
S2: granulating the mixture to obtain a recycled PS plastic; and
S3: preparing the recycled PS plastic into a film to obtain the recycled PS plastic film.

In some embodiments, when a content of the waste PS plastic is 100% and a content of the modification material is 0% based on the total weight of the recycled PS plastic film, S1 is omitted, S2 is as follows: granulating the waste PS plastic, and S3 is as follows: preparing a granular waste PS plastic material into a film to obtain the recycled PS plastic film.

In some embodiments, S3 includes: preparing the recycled PS plastic or the granular waste PS plastic material into the film by an extrusion-casting process or a blown-film process to obtain the recycled PS plastic film.

In some embodiments, at least one selected from the group consisting of an antistatic agent, a flame retardant, and a colorant is added during the step of preparing the recycled PS plastic into a film to obtain the recycled PS plastic film.

In order to solve the same technical problems, an embodiment of the present disclosure also provides an AM anti-theft label housing, including a sealing layer and the recycled PS plastic film described above, where the recycled PS plastic film and the sealing layer are arranged in a stacking manner.

In some embodiments, a thickness of the recycled PS plastic film is 0.20 mm to 0.45 mm.

In some embodiments, a thickness of the AM anti-theft label housing is 0.23 mm to 0.45 mm.

In some embodiments, the sealing layer is a PE film or a polypropylene (PP) film.

In some embodiments, a material of the sealing layer includes a recycled PE film with a recycling degree of 1-100%, or the material of the sealing layer includes a recycled PP film with a recycling degree of 1-100%.

In order to solve the same technical problems, an embodiment of the present disclosure also provides a method for preparing the AM anti-theft label housing, including:
arranging the sealing layer on the recycled PS plastic film to obtain an AM anti-theft label housing material, where the recycled PS plastic film is prepared by the method for preparing the recycled PS plastic film described above; and
preparing the AM anti-theft label housing material into the AM anti-theft label housing.

As a preferred solution, the sealing layer is a PE film or a PP film.

In some embodiments, a material of the sealing layer includes a recycled PE film with a recycling degree of 1-100%, or the material of the sealing layer includes a recycled PP film with a recycling degree of 1-100%.

In some embodiments, the method for preparing the AM anti-theft label housing includes:
preparing the recycled PS plastic film with the PE film or the PP film to obtain a laminated film; and
preparing the laminated film into the AM anti-theft label housing by a 50° C. to 80° C. hot-forming process.

In some embodiments, the hot-forming process is a vacuum forming process or a compression molding process with a concave mold and a convex mold.

In order to solve the same technical problems, an embodiment of the present disclosure also provides an AM anti-theft label, including the AM anti-theft label housing.

In some embodiments, the AM anti-theft label further includes at least one Resonator, a sealing cover, an bias, a double-sided adhesive, and a liner, where the sealing layer of the AM anti-theft label housing is connected to the sealing cover; a cavity is formed between the sealing layer and the sealing cover, and the resonator is accommodated in the cavity; and one side of the double-sided adhesive fixes the bias on the sealing cover, and the other side of the double-sided adhesive is connected to the liner.

In some embodiments, a notched izod impact strength of the recycled PS plastic is 5.7 kJ/m² to 17.0 kJ/m², and a thickness of the recycled PS plastic film is 0.20 mm to 0.45 mm; and

In some embodiments, when the AM anti-theft label housing is cut into a 2 mm-wide film strip, the film strip undergoes no brittle fracture after being completely folded in half along a length direction of the film strip and then unfolded.

Compared with the prior art, the embodiments of the present disclosure have the following beneficial effects: An embodiment of the present disclosure provides a recycled PS plastic film prepared from 100% of a waste PS plastic or prepared from a waste PS plastic and a modification material, where a content of the waste PS plastic is greater than or equal to 1% and less than 100% and a content of the modification material is greater than 0% and less than or equal to 99%. In each embodiment of the present disclosure, a waste PS plastic is used to prepare a recycled PS plastic film, which can save resources and is eco-friendly. In addition, the waste PS plastic is modified by the modification materials to improve the performance of the plastic, which is conducive to preparation of an AM anti-theft label housing with excellent performance. Correspondingly, an embodiment of the present disclosure also provides a preparation method of the recycled PS plastic film, an AM anti-theft label housing, a preparation method of the AM anti-theft label housing, and an AM anti-theft label.

### BRIEF DESCRIPTION OF THE DRAWINGS

FIG. 1 is a schematic structural diagram of an AM anti-theft label in an embodiment of the present disclosure; and

FIG. 2 is a flow chart of a preparation method of a recycled PS plastic film in an embodiment of the present disclosure,

where 1: AM anti-theft label housing; 2: resonator(s); 3: sealing cover; 4: bias; 5: double-sided adhesive; 51: double-sided adhesive base; 52: adhesive layer; and 6: liner.

### DETAILED DESCRIPTION

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts should fall within the protection scope of the present disclosure.

In an embodiment provided by the present disclosure, a recycled PS plastic film is provided, including a waste PS plastic, where based on a total weight of the recycled PS plastic film, a content of the waste PS plastic is 100%. When the recycled PS plastic film is made of 100% of the waste PS plastic, the use of the waste PS plastic is maximized to prepare the recycled PS plastic film, which saves resources as much as possible and allows the preparation of an AM anti-theft label housing with excellent performance.

As an example of the present disclosure, the recycled PS plastic is a recycled HIPS plastic, and the waste PS plastic is a waste HIPS plastic.

In an optional embodiment, when 100% of a rigid waste PS thick plate plastic is melted by the inventors to prepare a film, a flexible 0.20 mm to 0.45 mm film can be successfully prepared, which will not undergo brittle fracture as the thick plate PS. Thus, the 0.20 mm to 0.45 mm recycled PS of the present disclosure can be directly used (without modification) to prepare an AM anti-theft label housing without undergoing brittle fracture, which brings unexpected technical effects.

Correspondingly, an embodiment of the present disclosure also provides a method for preparing the recycled PS plastic film, including:
the waste PS plastic is granulated; and
a granular waste PS plastic material is prepared into a film to obtain the recycled PS plastic film, where based on a total weight of the recycled PS plastic film, a content of the waste PS plastic is 100%.

In a specific implementation, because a raw material from a recovery channel (such as a waste TV housing plastic) includes a variety of different components, for example, some TV housings are polycarbonate (PC)/acrylonitrile-butadiene-styrene copolymer (ABS) (PC/ABS), PS can be separated from other materials through infrared (IR) or density separation to obtain a pure PS material, which facilitates the subsequent recycling as well as modified recycling. For example, a recovered waste TV housing plastic can first undergo treatments such as crushing, washing, separation, and drying to obtain a waste PS plastic.

In some embodiments, the preparing a granular waste PS plastic material into a film to obtain the recycled PS plastic film specifically includes: the granular waste PS plastic material is prepared into the film by an extrusion-casting process or a blown-film process to obtain the recycled PS plastic film.

In some embodiments, a thickness of the recycled PS plastic film is 0.20 mm to 0.45 mm.

In some embodiments, a thickness of the recycled PS plastic film is 0.25 mm to 0.45 mm, or 0.20 mm to 0.38 mm, or 0.25 mm to 0.38 mm, or 0.31 mm to 0.45 mm, or 0.20 mm to 0.32 mm.

In another embodiment, the recycled PS plastic film includes a waste PS plastic and a modification material, where based on the total weight of the recycled PS plastic film, a content of the waste PS plastic is greater than or equal to 1% and less than 100% and a content of the modification material is greater than 0% and less than or equal to 99%.

In the above embodiment, the recycled PS plastic film is made of the waste PS plastic and the modification material, where the content of the waste PS plastic is greater than or equal to 1% and less than 100% and the content of the modification material is greater than 0% and less than or equal to 99%, which makes full use of the waste PS plastic to prepare the recycled PS plastic film, thereby saving resources as much as possible. In a specific application, when a recovered waste PS material is insufficient or the performance of a recycled PS plastic film needs to be further improved, a waste PS plastic can be modified by adding a modification material, which is conducive to the preparation of an AM anti-theft label housing with excellent performance.

Specifically, the use of a waste material and a modification and recycling technology thereof to prepare an AM anti-theft label with a recycled plastic (namely, a “Pro-green” AM anti-theft soft label) can not only alleviate the pollution of a large number of waste electrical devices such as waste TV housing plastics to the environment, but also turn waste into treasure and save resources. In addition, when a waste PS plastic is modified by blending a toughening agent to improve an impact strength of the plastic and maintain tensile and bending strengths and excellent fluidity, a 0.20 mm to 0.45 mm recycled PS film can be prepared, and then the recycled PS film can be used to prepare an AM label housing to meet the requirements of producing “Pro-green” AM anti-theft soft labels.

In a specific implementation, a content of the waste PS plastic is greater than or equal to 1% and less than 100%, such as 1%, 5%, 10%, 15%, 20%, 25%, 30%, 35%, 40%, 41%, 42%, 43%, 44%, 45%, 46%, 47%, 48%, 49%, 50%, 51%, 52%, 53%, 54%, 55%, 56%, 57%, 58%, 60%, 65%, 70%, 73%, 76%, 80%, 82%, 85%, 88%, 90%, 92%, 95%, or 99%, and a specific content of the waste PS plastic can be set according to actual requirements, which will not be described in detail here; and a content of the modification material is greater than 0% and less than or equal to 99%, such as 1%, 5%, 10%, 15%, 20%, 24%, 25%, 26%, 30%, 35%, 40%, 45%, 50%, 55%, 60%, 65%, 70%, 75%, 80%, 85%, 90%, or 99%; and a specific content of the modification material can be set according to actual requirements, which will not be described in detail here. Preferably, based on the total weight of the recycled PS plastic film, the content of the waste PS plastic is 10% to 76% and the content of the modification material is 24% to 90%.

In some embodiments, the modification material includes at least one selected from the group consisting of a virgin PS material and an additive. For example, the additive includes a toughening agent. The toughening agent includes at least one selected from the group consisting of SBS and SBR. In an embodiment of the present disclosure, since SBS and SBR are excellent toughening agents; molecular segments of the SBS, SBR and waste PS plastic all include styrene units, the toughening agents SBR and SBS have excellent compatibility with the waste PS plastic, and can toughen the waste PS plastic to some degree. Optionally, the additive may also include OMMT (for example nano-organic montmorillonite). The use of OMMT to modify the waste PS plastic can improve the impact strength, tensile strength, bending strength, and fluidity of the plastic, which is conducive to the preparation of an AM anti-theft label housing with excellent performance.

In some embodiments, the toughening agent is SBS; and based on a total weight of the recycled PS plastic film, a content of the SBS is greater than 0% and less than or equal to 25%, such as 1%, 3%, 5%, 7%, 9%, 10%, 13%, 15%, 16%, 17%, 18%, 19%, 20%, 21%, 22%, 23%, 24%, or 25%, and a content of the OMMT (for example nano-organic montmorillonite) is greater than 0% and less than or equal to 6%, such as 1%, 2%, 3%, 4%, 5%, or 6%. Preferably, based on the total weight of the recycled PS plastic film, a content of the SBS is 15% to 25% and a content of the OMMT is 2% to 6%. For example, based on the total weight of the recycled PS plastic film, a content of the SBS is 20% and a content of the OMMT is 4%.

In some embodiments, the toughening agent is SBR; and based on a total weight of the recycled PS plastic film, a content of the SBR is greater than 0% and less than or equal to 35%, such as 1%, 3%, 5%, 10%, 15%, 20%, 25%, 26%, 27%, 28%, 29%, 30%, 31%, 32%, 33%, 34%, or 35%, and a content of the OMMT (for example nano-organic montmorillonite) is greater than 0% and less than or equal to 6%, such as 1%, 2%, 3%, 4%, 5%, or 6%. Preferably, based on the total weight of the recycled PS plastic film, a content of the SBR is 25% to 35%, such as 25%, 26%, 27%, 28%, 29%, 30%, 31%, 32%, 33%, 34%, or 35%, and a content of the OMMT is 2% to 6%, such as 2%, 3%, 4%, 5%, or 6%. For example, based on the total weight of the recycled PS plastic film, the content of the SBR is 30% and the content of the OMMT is 4%.

In some embodiments, the toughening agent includes SBS and SBR; and based on a total weight of the recycled PS plastic film, a content of the SBS is greater than 0% and less than or equal to 25%, such as 1%, 3%, 5%, 7%, 9%, 10%, 13%, 15%, 16%, 17%, 18%, 19%, 20%, 21%, 22%, 23%, 24%, or 25%, a content of the SBR is greater than 0% and less than or equal to 35%, such as 1%, 3%, 5%, 10%, 15%, 20%, 25%, 26%, 27%, 28%, 29%, 30%, 31%, 32%, 33%, 34%, or 35%, a content of the OMMT (for example nano-organic montmorillonite) is greater than 0% and less than or equal to 6%, such as 1%, 2%, 3%, 4%, 5%, or 6%, and a total content of the SBS, the SBR, and the OMMT is less than or equal to 60% (greater than 0% and less than or equal to 60%, for example), such as 1%, 5%, 10%, 15%, 20%, 25%, 30%, 32%, 35%, 37%, 39%, 42%, 43%, 44%, 45%, 46%, 47%, 48%, 49%, 50%, 51%, 52%, 53%, 54%, 55%, 56%, 57%, 58%, 59%, or 60%. Preferably, a total content of the SBS, the SBR, and the OMMT is greater than 0% and less than or equal to 49%.

It should be noted that the toughening agent SBR or SBS has a great impact on a flow rate of a melt of a modified waste PS plastic, and with the increase of the toughening agent, the flow rate of the melt of the modified waste PS plastic increases and the uniformity of the melt is enhanced. A total content of the SBS, the SBR, and the OMMT (three modification components) in the embodiment of the present disclosure does not exceed 60%. This is mainly because the OMMT is equivalent to a physical cross-linking point in a toughening-modified waste PS plastic matrix. When a content of the OMMT is too low, an intercalation process is easy to reach a balance, and OMMT sheets can be peeled off or completely embedded to reinforce a modified plastic in a two-dimensional (2D) direction. Therefore, an elastic modulus of a modified plastic increases significantly with the increase of a content of the OMMT. When a content of the OMMT is too high, only a part of the OMMT is peeled off or intercalated by a modified plastic, and the other part of the OMMT can only exist in the original particle state and partly undergoes agglomeration, which weakens an action of the OMMT on a molecular chain of the modified plastic in a 2D direction and reduces a bending strength of the composite material. Therefore, the addition of a small amount of OMMT can improve the bending properties of a nanocomposite. An elongation at break of a modified waste PS plastic is slightly decreased with the increase of OMMT, with a small decrease.

Correspondingly, an embodiment of the present disclosure also provides a method for preparing the recycled PS plastic film, including:
the waste PS plastic and the modification material are mixed to obtain a mixture;
the mixture is granulated to obtain a recycled PS plastic; and
the recycled PS plastic is prepared into a film to obtain the recycled PS plastic film,
where based on a total weight of the recycled PS plastic film, the content of the waste PS plastic is greater than or equal to 1% and less than 100% and the content of the modification material is greater than 0% and less than or equal to 99%.

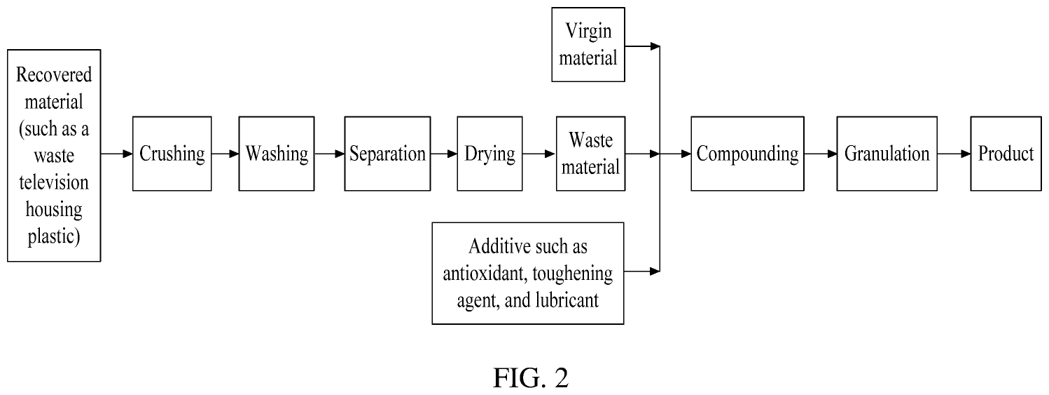

As shown in FIG. 2, in a specific implementation, because a raw material from a recovery channel (such as a waste TV housing plastic) includes a variety of different components, for example, some TV housings are PC/ABS, PS can be separated from other materials through IR or density separation to obtain a pure PS material, which facilitates the subsequent modification. For example, as shown in FIG. 2, a recovered waste TV housing plastic can first undergo treatments such as crushing, washing, separation, and drying to obtain a waste PS plastic, then the waste PS plastic can be further mixed with modification materials such as a virgin PS material and an additive, and then granulated, to obtain a recycled PS plastic; and then the recycled PS plastic can be prepared into a desired product according to actual use requirements.

In some embodiments, the preparing the recycled PS plastic into a film to obtain the recycled PS plastic film specifically includes: the recycled PS plastic is prepared into the film by an extrusion-casting process or a blown-film process to obtain the recycled PS plastic film.

In some embodiments, at least one selected from the group consisting of an antistatic agent, a flame retardant, and a colorant is added during formation of the recycled PS plastic film from the recycled PS plastic. In a specific implementation, a virgin PS material can also be blended into the recycled PS plastic to prepare a PS film, and of course, other substances can also be added according to actual use requirements, which will not described in detail here.

Correspondingly, an embodiment of the present disclosure also provides an AM anti-theft label housing, including a sealing layer and the recycled PS plastic film provided in any one of the above embodiments, where the recycled PS plastic film and the sealing layer are arranged in a stacking manner.

In some embodiments, a thickness of the recycled PS plastic film is 0.20 mm to 0.45 mm.

In some embodiments, a thickness of the recycled PS plastic film is 0.25 mm to 0.45 mm, or 0.20 mm to 0.38 mm, or 0.25 mm to 0.38 mm, or 0.31 mm to 0.45 mm, or 0.20 mm to 0.32 mm.

In some embodiments, a thickness of the AM anti-theft label housing is 0.25 mm to 0.45 mm.

In some embodiments, the sealing layer is a PE film or a PP film.

In some embodiments, the PE film includes a recycled PE film of with a recycling degree of 1-100%.

In some embodiments, the PP film includes a recycled PP film with a recycling degree of 1-100%.

In some embodiments, a material of the sealing layer includes a recycled PE film with a recycling degree of 1-100%, or the material of the sealing layer includes a recycled PP film with a recycling degree of 1-100%.

Correspondingly, an embodiment of the present disclosure also provides a method for preparing the AM anti-theft label housing, including:
the sealing layer is arranged on the recycled PS plastic film to obtain an AM anti-theft label housing material, where the recycled PS plastic film is prepared by the method for preparing the recycled PS plastic film described above; and
the AM anti-theft label housing material is prepared into the AM anti-theft label housing.

In some embodiments, the sealing layer is a PE film or a PP film; and the arranging the sealing layer on the recycled PS plastic film to obtain an AM anti-theft label housing material specifically includes:
the recycled PS plastic film is compounded with the PE film or the PP film to obtain a laminated film; and
the laminated film is prepared into the AM anti-theft label housing by a 50° C. to 80° C. hot-forming process; where the hot-forming process is a vacuum forming process or a compression molding process with a concave mold and a convex mold.

Correspondingly, an embodiment of the present disclosure also provides an AM anti-theft label, including the AM anti-theft label housing.

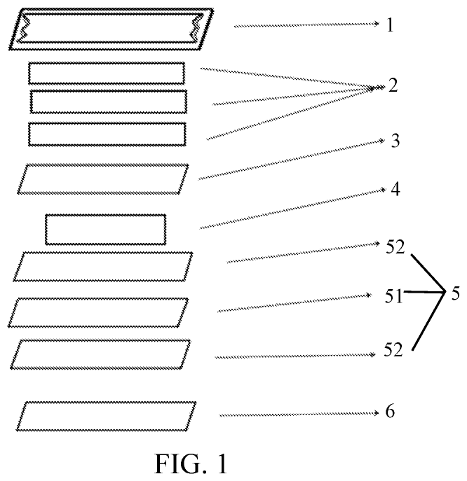

As shown in FIG. 1, in some embodiments, the AM anti-theft label further includes at least one resonator 2, a sealing cover 3, a bias 4, a double-sided adhesive 5, and a liner 6, where the sealing layer of the AM anti-theft label housing 1 is connected to the sealing cover 3; a cavity is formed between the sealing layer and the sealing cover 3, and the resonator 2 is accommodated in the cavity; and one side of the double-sided adhesive 5 fixes the bias 4 on the sealing cover 3, and the other side of the double-sided adhesive 5 is connected to the liner.

In a specific implementation, for example, the AM anti-theft label housing 1 is made of a PS/PE laminated film and the sealing cover 3 is made of a PE/PET laminated film; and the resonator 2 is encapsulated into a resonant cavity of the plastic housing 1 through heat sealing on a PE/PE side (namely, a PE side of the AM anti-theft label housing 1 and a PE side of the sealing cover 3). The bias 4 is fixed on a PET side of the encapsulated AM anti-theft label housing 1 through the double-sided adhesive 5, and after die-cutting, a label can be removed from the liner 6 and attached to a surface of a commodity. For example, the AM anti-theft label housing 1 is a PS/PE laminated film material (that is, a sealing layer of the AM anti-theft label housing is a PE film) and has a thickness of 0.23 mm to 0.45 mm; the sealing cover 3 is a PE/PET laminated film and has a thickness of about 0.1 mm; and the double-sided adhesive 5 includes a double-sided adhesive base 51 and adhesive layers 52 arranged on two sides of the double-sided adhesive base 51, the double-sided adhesive base 51 is PET, and the double-sided adhesive 5 has a thickness of about 0.01 mm. Of course, the AM anti-theft label can also be set to another structure according to actual use requirements, which will not be described in detail here.

In some embodiments, a notched izod impact strength of the recycled PS plastic is 5.7 kJ/m² to 17.0 kJ/m², and a thickness of the recycled PS plastic film is 0.20 mm to 0.45 mm.

In some embodiments, when the AM anti-theft label housing is cut into a 2 mm-wide film strip, the film strip undergoes no brittle fracture after being completely folded in half along a length direction of the film strip and then unfolded.

In a specific implementation, the AM label housing is cut into the 2 mm-wide strip and the strip is fully folded in half and then unfolded to determine whether the label housing is brittle or flexible. For example, the label housing is cut into a 2 mm-wide strip, and after being completely folded in half along a length direction of the strip and then unfolded, the strip does not undergo fracture, that is, the strip undergoes no complete brittle fracture at a bending site; and if the strip undergoes no fracture but undergoes blushing or partial rupture without fracture, it is considered to be no brittle fracture.

The preparation method of the AM anti-theft label housing provided in the present disclosure is described below in conjunction with the following examples.

### Example 1

Based on a total weight of a recycled PS plastic film, 100% of a waste PS plastic was used to prepare the recycled PS plastic film. The waste PS plastic had a notched izod impact strength only of 5.7 kJ/m². A recycled PS plastic film with a thickness of 0.25 mm to 0.38 mm could be successfully prepared from the waste PS plastic by an extrusion-casting process, then the recycled PS plastic film was compounded with a PE film, and then a resulting laminated film was used to prepare an AM anti-theft soft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 2

A waste PS plastic was modified with a rubber elastomer SBS for toughening. Based on a total weight of a recycled PS plastic film, a content of the waste PS plastic was 76%, a content of the SBS was 20%, and a content of OMMT was 4% (mass fraction). A modified waste PS plastic had a notched izod impact strength of up to 12.96 kJ/m², which was 7.26 kJ/m² higher than the 5.7 kJ/m² of the unmodified waste PS plastic; and the modified waste PS plastic had an excellent tensile strength specifically of 30.07 MPa.

A recycled PS plastic film with a thickness of 0.25 mm to 0.38 mm was prepared from the modified waste PS plastic by an extrusion-casting process, during which an antistatic agent, a color masterbatch, and the like were added; then the recycled PS plastic film was compounded with a PE film; and then a resulting laminated film was used to prepare an AM anti-theft soft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 3

A waste PS plastic was modified with a rubber elastomer SBR for toughening. Based on a total weight of a recycled PS plastic film, a content of the waste PS plastic was 66%, a content of the SBR was 30%, and a content of OMMT was 4% (mass fraction). A modified waste PS plastic had a notched izod impact strength of up to 11.86 kJ/m², which was 6.16 kJ/m² higher than the 5.7 kJ/m² of the unmodified waste PS plastic; and the modified waste PS plastic had an excellent tensile strength specifically of 28.67 MPa. A recycled PS plastic film with a thickness of 0.25 mm to 0.38 mm was prepared from the modified waste PS plastic by an extrusion-casting process, during which an antistatic agent, a color masterbatch, and the like were added; then the recycled PS plastic film was compounded with a PE film; and then a resulting laminated film was used to prepare an AM anti-theft soft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 4

A waste PS plastic was modified with rubber elastomers SBS and SBR for toughening. Based on a total weight of a recycled PS plastic film, a content of the waste PS plastic was 51% and a total content of SBS, SBR, and OMMT (three modification components) was 49%. A recycled PS plastic film with a thickness of 0.25 mm to 0.38 mm was prepared from the modified waste PS plastic by an extrusion-casting process, during which an antistatic agent, a color masterbatch, and the like were added; then the recycled PS plastic film was compounded with a PE film; and then a resulting laminated film was used to prepare an AM anti-theft soft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 5

Based on a total weight of a recycled PS plastic film, 51% of a recycled PS plastic and 49% of a virgin PS material were used to prepare the recycled PS plastic film. Specifically, a recycled PS plastic film with a thickness of 0.25 mm to 0.38 mm was prepared from the recycled PS plastic and the virgin PS material by a blown-film process, during which an antistatic agent, a flame retardant, and the like were added; then the recycled PS plastic film was compounded with a PE film; and then a resulting laminated film was used to prepare an AM anti-theft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 6

Based on a total weight of a recycled PS plastic film, 10% of a recycled PS plastic and 90% of a virgin PS material were used to prepare the recycled PS plastic film. Specifically, a recycled PS plastic film with a thickness of 0.25 mm to 0.38 mm was prepared from the recycled PS plastic and the virgin PS material by a blown-film process, during which an antistatic agent, a flame retardant, and the like were added; then the recycled PS plastic film was compounded with a PE film; and then a resulting laminated film was used to prepare an AM anti-theft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 7

A waste PS plastic was modified with a rubber elastomer SBS for toughening. Based on a total weight of a recycled PS plastic film, a content of the waste PS plastic was 95% and a content of the SBS was 5%. A recycled PS plastic film with a thickness of 0.25 mm to 0.38 mm was prepared from the modified waste PS plastic by an extrusion-casting process, during which an antistatic agent, a color masterbatch, and the like were added; then the recycled PS plastic film was compounded with a PE film; and then a resulting laminated film was used to prepare an AM anti-theft soft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 8

Based on a total weight of a recycled PS plastic film, 100% of a recycled PS plastic was used to prepare the PS film. A waste PS plastic was modified with a rubber elastomer SBS for toughening. Based on the total weight of the recycled PS plastic film, a content of the waste PS plastic was 90% and a content of the SBS was 10%. A recycled PS plastic film with a thickness of 0.25 mm to 0.38 mm was prepared from the modified waste PS plastic by an extrusion-casting process, during which an antistatic agent, a color masterbatch, and the like were added; then the recycled PS plastic film was compounded with a PE film; and then a resulting laminated film was used to prepare an AM anti-theft soft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 9

A waste PS plastic was modified with a rubber elastomer SBS for toughening. Based on a total weight of a recycled PS plastic film, a content of the waste PS plastic was 82%, a content of the SBS was 10%, and a content of a virgin PS material was 8%. A recycled PS plastic film with a thickness of 0.25 mm to 0.38 mm was prepared from the modified waste PS plastic by an extrusion-casting process, during which an antistatic agent, a color masterbatch, and the like were added; then the recycled PS plastic film was compounded with a PE film; and then a resulting laminated film was used to prepare an AM anti-theft soft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 10

Based on a total weight of a recycled PS plastic film, 1% of a waste PS plastic and 99% of a virgin PS material were used to prepare the PS film. Specifically, a recycled PS plastic film with a thickness of 0.25 mm to 0.38 mm was prepared from the waste PS plastic and the virgin PS material by a blown-film process, during which an antistatic agent, a flame retardant, and the like were added; then the recycled PS plastic film was compounded with a PE film; and then a resulting laminated film was used to prepare an AM anti-theft label housing through 50° C. to 80° C. hot-forming (vacuum forming or compression molding with a concave mold and a convex mold). The label housing was cut into a 2 mm-wide strip, and then the strip was completely folded in half along a length direction and then unfolded. After the folding and unfolding, the strip underwent no brittle fracture.

### Example 11

Based on a total weight of a recycled PS plastic film, 100% of a waste PS plastic was used to prepare the recycled PS plastic film. A recycled PS plastic film with a thickness of 0.31 mm to 0.45 mm could be successfully prepared from the waste PS plastic by an extrusion-casting process, then the recycled PS plastic film was compounded with a 100%-recycled PE film (0.06 mm), and then a resulting laminated film was used to prepare an AM anti-theft soft label housing through 50° C. to 80° C. hot-forming (vacuum forming or compression molding). A prepared label housing was cut into a 2 mm-wide strip, and then the strip was completely folded in half along a length direction and then unfolded. After the folding and unfolding, the strip underwent no brittle fracture. Resonators (there may be 1 to 5 resonators, and in this example, there were 2 resonators) were placed in a cavity of a prepared label housing, a PE/PE side was heat-sealed with PE/PET (sealing cover material), a bias was fixed by an adhesive above the cavity and then covered with a double-sided adhesive and a liner, and a resulting product was die-cut to obtain the AM anti-theft label of the present disclosure.

### Example 12

Based on a total weight of a recycled PS plastic film, 100% of a waste PS plastic was used to prepare the recycled PS plastic film. A recycled PS plastic film with a thickness of 0.20 mm to 0.32 mm could be successfully prepared from the waste PS plastic by an extrusion-casting process, then the recycled PS plastic film was compounded with a 1%-recycled PP film (0.03 mm), and then a resulting laminated film was used to prepare an AM anti-theft soft label housing through 50° C. to 80° C. hot-forming (compression molding with a concave mold and a convex mold). A prepared label housing was cut into a 2 mm-wide strip, and then the strip was completely folded in half along a length direction and then unfolded. After the folding and unfolding, the strip underwent no brittle fracture. Resonators (there may be 1 to 5 resonators, and in this example, there were 4 resonators) were placed in a cavity of a prepared label housing, a PP/PP side was heat-sealed with PP/PET (sealing cover material), a bias was fixed by an adhesive above the cavity and then covered with a double-sided adhesive and a liner, and a resulting product was die-cut to obtain the AM anti-theft label of the present disclosure.

It should be noted that, according to Chinese patent application CN201711280664.8, the following steps can be used to determine whether a sample of a PS part of an AM label housing includes a recycled PS plastic material: (1) a sample of a PS part of an AM label housing is collected; (2) the sample is identified by at least three methods selected from the group consisting of IR spectroscopy analysis, headspace gas chromatography (HS-GC) analysis, electron microscopy (EM) analysis, and elemental distribution analysis, and when the at least three methods are used for identification, it can be determined that the sample includes 1% to 100% of a recycled PS plastic material.

Compared with the prior art, the embodiments of the present disclosure have the following beneficial effects: An embodiment of the present disclosure provides a recycled PS plastic film prepared from 100% of a waste PS plastic or prepared from a waste PS plastic and a modification material, where the content of the waste PS plastic is greater than or equal to 1% and less than 100% and the content of the modification material is greater than 0% and less than or equal to 99%. In the embodiments of the present disclosure, a waste PS plastic is used to prepare a recycled PS plastic film, which can save resources and is eco-friendly. In addition, the waste PS plastic is modified by the modification material to improve the performance of the plastic, which is conducive to preparation of an AM anti-theft label housing with excellent performance. Correspondingly, an embodiment of the present disclosure also provides a preparation method of the recycled PS plastic film, an AM anti-theft label housing, a preparation method of the AM anti-theft label housing, and an AM anti-theft label.

The above are only preferred implementations of the present disclosure. It should be noted that several improvements and replacements may further be made by a person of ordinary skill in the art without departing from the technical principle of the present disclosure, and such improvements and replacements should also be deemed as falling within the protection scope of the present disclosure.

1. A recycled polystyrene (PS) plastic film, comprising a waste PS plastic and a modification material, wherein based on a total weight of the recycled PS plastic film, a content of the waste PS plastic is greater than or equal to 1% and less than or equal to 100% and a content of the modification material is greater than or equal to 0% and less than or equal to 99%; and a thickness of the recycled PS plastic film is 0.20 mm to 0.45 mm.

2. The recycled PS plastic film according to claim 1, wherein based on the total weight of the recycled PS plastic film, the content of the waste PS plastic is 100% and the content of the modification material is 0%.

3. The recycled PS plastic film according to claim 1, wherein based on the total weight of the recycled PS plastic film, the content of the waste PS plastic is greater than or equal to 1% and less than 100% and the content of the modification material is greater than 0% and less than or equal to 99%.

4. The recycled PS plastic film according to claim 3, wherein based on the total weight of the recycled PS plastic film, the content of the waste PS plastic is 10% to 76% and the content of the modification material is 24% to 90%.

5. The recycled PS plastic film according to claim 1, wherein the modification material comprises at least one selected from the group consisting of a virgin PS material and an additive;
preferably, the additive comprises a toughening agent; and
preferably, the toughening agent comprises at least one selected from the group consisting of a styrene-butadiene-styrene block copolymer (SBS) and a styrene-butadiene rubber (SBR).

6. The recycled PS plastic film according to claim 5, wherein the additive further comprises organic montmorillonite (OMMT), and the toughening agent is SBS; based on the total weight of the recycled PS plastic film, a content of the SBS is greater than 0% and less than or equal to 25% and a content of the OMMT is greater than 0% and less than or equal to 6%; and
preferably, based on the total weight of the recycled PS plastic film, the content of the SBS is 20% and the content of the OMMT is 4%.

7. The recycled PS plastic film according to claim 5, wherein the additive further comprises OMMT, and the toughening agent is SBR; based on the total weight of the recycled PS plastic film, a content of the SBR is greater than 0% and less than or equal to 35% and a content of the OMMT is greater than 0% and less than or equal to 6%; and
preferably, based on the total weight of the recycled PS plastic film, the content of the SBR is 30% and the content of the OMMT is 4%.

8. The recycled PS plastic film according to claim 5, wherein the additive further comprises OMMT, and the toughening agent comprises SBS and SBR; and based on the total weight of the recycled PS plastic film, the content of the SBS is greater than 0% and less than or equal to 25%, the content of the SBR is greater than 0% and less than or equal to 35%, the content of the OMMT is greater than 0% and less than or equal to 6%, and a total content of the SBS, the SBR, and the OMMT is less than or equal to 60%.

9. The recycled PS plastic film according to claim 1, wherein the waste PS plastic is a waste high-impact polystyrene (HIPS) plastic, and the recycled PS plastic is a recycled HIPS plastic.

10. A method for preparing the recycled PS plastic film according to claim 1, comprising:
S1: mixing the waste PS plastic and the modification material to obtain a mixture;
S2: granulating the mixture to obtain a recycled PS plastic; and
S3: preparing the recycled PS plastic into a film to obtain the recycled PS plastic film,
wherein when a content of the waste PS plastic is 100% and a content of the modification material is 0% based on the total weight of the recycled PS plastic film, S1 is omitted, S2 is as follows: granulating the waste PS plastic, and S3 is as follows: preparing a granular waste PS plastic material into a film to obtain the recycled PS plastic film.

11. The method for preparing the recycled PS plastic film according to claim 10, wherein S3 comprises:
preparing the recycled PS plastic or the granular waste PS plastic material into the film by an extrusion-casting process or a blown-film process to obtain the recycled PS plastic film.

12. The method for preparing the recycled PS plastic film according to claim 10, wherein at least one selected from the group consisting of an antistatic agent, a flame retardant, and a colorant is added during the step of preparing the recycled PS plastic into a film to obtain the recycled PS plastic film.

13. An acousto-magnetic (AM) anti-theft label housing, comprising a sealing layer and the recycled PS plastic film according to claim 1, wherein the recycled PS plastic film and the sealing layer are arranged in a stacking manner.

14. The AM anti-theft label housing according to claim 13, wherein a thickness of the AM anti-theft label housing is 0.23 mm to 0.45 mm.

15. The AM anti-theft label housing according to claim 13, wherein the sealing layer is a polyethylene (PE) film or a polypropylene (PP) film; and
preferably, a material of the sealing layer comprises a recycled PE film with a recycling degree of 1-100%, or the material of the sealing layer comprises a recycled PP film with a recycling degree of 1-100%.

16. A method for preparing the AM anti-theft label housing according to claim 13, comprising:
arranging the sealing layer on the recycled PS plastic film to obtain an AM anti-theft label housing material; and
preparing the AM anti-theft label housing material into the AM anti-theft label housing,
wherein a preparation method of the recycled PS plastic film comprises:
S1: mixing the waste PS plastic and the modification material to obtain a mixture;
S2: granulating the mixture to obtain a recycled PS plastic; and
S3: preparing the recycled PS plastic into a film to obtain the recycled PS plastic film,
wherein when a content of the waste PS plastic is 100% and a content of the modification material is 0% based on the total weight of the recycled PS plastic film, S1 is omitted, S2 is as follows: granulating the waste PS plastic, and S3 is as follows: preparing a granular waste PS plastic material into a film to obtain the recycled PS plastic film.

17. The method for preparing the AM anti-theft label housing according to claim 16, wherein the sealing layer is a PE film or a PP film;
preferably, a material of the sealing layer comprises a recycled PE film with a recycling degree of 1-100%, or the material of the sealing layer comprises a recycled PP film with a recycling degree of 1-100%; and
preferably, the method for preparing the AM anti-theft label housing comprises:
preparing the recycled PS plastic film with the PE film or the PP film to obtain a laminated film; and
preparing the laminated film into the AM anti-theft label housing by a 50° C. to 80° C. hot-forming process,
wherein preferably, the hot-forming process is a vacuum forming process or a compression molding process with a concave mold and a convex mold.

18. An AM anti-theft label, comprising the AM anti-theft label housing according to claim 13.

19. The AM anti-theft label according to claim 18, further comprising at least one resonator, a sealing cover, an bias, a double-sided adhesive, and a liner, wherein the sealing layer of the AM anti-theft label housing is connected to the sealing cover; a cavity is formed between the sealing layer and the sealing cover, and the resonator is accommodated in the cavity; and one side of the double-sided adhesive fixes the bias on the sealing cover, and the other side of the double-sided adhesive is connected to the liner.

20. The AM anti-theft label according to claim 18, wherein a notched izod impact strength of the recycled PS plastic is 5.7 kJ/m² to 17.0 kJ/m², and a thickness of the recycled PS plastic film is 0.20 mm to 0.45 mm; and
preferably, when the AM anti-theft label housing is cut into a 2 mm-wide film strip, the film strip undergoes no brittle fracture after being completely folded in half along a length direction of the film strip and then unfolded.
